(19) United States
(12) Patent Application Publication
(10) Pub. No.: US 2026/0029353 A1
(43) Pub. Date: Jan. 29, 2026

(54) Method and Device for Inspecting the Base of a Container

(71) Applicant: Thomas Huhn, München (DE)

(72) Inventor: Thomas Huhn, München (DE)

(73) Assignee: Emhart Glass SA, Steinhausen (CH)

(21) Appl. No.: 19/279,686

(22) Filed: Jul. 24, 2025

(30) Foreign Application Priority Data
Jul. 25, 2024 (DE) 10 2024 121 199.7

(51) Int. Cl. G01N 21/90

(52) U.S. Cl. CPC G01N 21/9036; G01N 21/9009

(57) ABSTRACT

A method for creating an image of a base of a container uses a matrix camera. The matrix camera captures a series of individual captures of regions of the base of the container which overlap in sections, while the base of the container is transilluminated by a light source arranged on the side opposite the matrix camera. A digital image of the base of the container is compiled from the individual captures. The invention is characterized in that the region of the base of the container captured in an individual capture is defined by an illumination structure, that the illumination structure is shifted relative to the base of the container between two individual captures, and that the container and the matrix camera remain rotationally invariant to one another during the capturing of the series of individual captures. The invention also relates to a device for carrying out the method.

### CROSS-REFERENCE TO RELATED PATENT APPLICATIONS

This Patent Application claims the benefit of German Patent Application No. 102024121199.7, filed Jul. 25, 2024, the entire teachings and disclosure of which are incorporated herein by reference thereto.

### FIELD OF THE INVENTION

The present invention relates to a method for creating an image of a translucent or transparent base of a container according to the preamble of claim 1 as well as to a device suitable for such a method.

### BACKGROUND OF THE INVENTION

In the context of the invention, “translucent” means that the base of the container is capable, in the broadest sense, of completely or at least partially transmitting electromagnetic waves (in particular in the visible spectral range). The lower the proportion of scattering of the electromagnetic radiation when passing through the base, the more likely the base can be described to be “transparent,” especially in the (complete) absence of scattering. The transition between transparent and translucent is fluid. Every transparent material is always also translucent.

In particular during the industrial production of glass containers, imperfections, such as defects, cracks, color inclusions, foreign material inclusions, or air inclusions, can occur in the base of the container, albeit to a small extent. If such imperfections are detected in a timely manner, the defective containers can be discharged from the manufacturing process. The invention is intended to enable the detection of such defects.

A generic method for creating images of the base of a glass container can be gathered in DE102022123099A1. There, several individual captures of the base of the glass container are captured by a matrix camera while the glass container rotates about its own axis relative to the matrix camera before the individual captures are combined to form an image.

A further method and a corresponding device for inspecting containers is described in DE102022123101A1. Here, an opaque support structure with at least two recesses is located beneath the container, and the container is also rotated during the inspection.

EP2434276B1 discloses a further inspection method for examining transparent or translucent containers for defects such as cracks, fractures, bubbles, or the like. The containers are continuously conveyed along a conveying direction by a conveyor system. Each container passes through an inspection station where a non-contact inspection of at least a selected region of each container takes place.

Further devices and methods for inspecting transparent or translucent containers for imperfections can be found in DE102005044206B4, DE2545678A1, DE102011013551A1, DE102020118470A1, DE20010813U1, DE29518639U1, DE69408899T2, or EP0472881A2.

In particular, the more recent methods according to DE102022123101A1 or DE102022123099A1, which employ matrix cameras, already provide a very high rate of success in detecting special or imperfect regions in containers. However, there is still room for improvement for certain applications.

### SUMMARY OF THE APPLICATION

The object of the present invention is to further improve the reliability and range of applications when inspecting bases of containers.

In a first example, a method for creating an image of a translucent or even transparent base of a container is provided which uses a matrix camera with pixels arranged in a plurality of rows and a plurality of columns. Using the matrix camera, a series of individual captures of regions of the base of the container are captured, where adjacent individual captures overlap in sections. During a single capturing, the base of the container is transilluminated by a light source located on the side of the container opposite the matrix camera. A digital image of the base of the container is compiled from the series of individual captures. The container as a whole, or at least its base, can be made, for example, of glass or translucent or even transparent plastic material. The camera can be a CCD camera or a CMOS camera, e.g., a so-called high-speed camera. The light source can be a pulsed light source which is preferably operated in synchronization with the capturing of the individual captures by the matrix camera.

Typically, the containers are not affixed in the machine but are moved from inspection station to inspection station with the aid of a star wheel. The star wheel traditionally pushes the containers over metal plates, so-called dead plates. These plates are previously completely opaque and thus prevent background illumination. Capturing and compiling individual captures now makes it possible to acquire images of the container base without having to give up the option of carrying or supporting the containers.

In contrast to conventional methods, this method is characterized in that the region of the base of the container captured in an individual capture is defined by an illumination structure. The term “illumination structure” is synonymous with “structured illumination.” This means that not the entire surface of the base of the container is transilluminated, at least not with uniform intensity, but that there are illuminated and non-illuminated regions (i.e., regions illuminated with lower intensity) of the base during the creation of individual captures. In the simplest case, there is an illuminated region surrounded by non-illuminated regions on one side, two sides, or more. Alternatively, there may be multiple illuminated regions. These multiple illuminated regions can be arranged symmetrically or even regularly, for example, in a one-dimensional or two-dimensional pattern.

The method is further characterized in that the illumination structure is shifted relative to the base of the container between two individual captures, and that the container and the matrix camera remain rotationally invariant to one another during the capturing of the series of individual captures. In the context of the invention, “rotationally invariant” means that the container and the matrix camera do not rotate relative to one another. This measure significantly distinguishes the method from the methods known, for example, from DE102022123099A1 or DE102022123101A1, which were each based on a relative rotation of the container and the camera. In the method according to the invention, however, the container and the matrix camera can remain stationary relative to one another. In contrast, scanning the base of the container is achieved in that the illumination structure is moved between two individual captures. In this way, the illumination structure can, in a sense, “wander” across the base of the container. The relative shift of the illumination structure relative to the base of the container between two individual captures can be achieved in that the illumination structure and/or the container moves.

The illumination structure can be configured, for example, as an element according to the description above. However, it is more expedient to configure the illumination unit (light source) as a full-surface and stationary unit, and to move an upstream structure. This has the advantage, among other things, that the structure is subject to a certain amount of wear due to the containers being pushed thereover and is easier and cheaper to replace than a complex illumination unit.

A method according to an example has several advantages over previous testing methods. In previous methods, for example, measurement errors could arise for the reason that the containers had to be rotated relative to the camera. Slippage could occur during this relative rotation, which meant that the extent of the relative rotation could not be determined with complete precision. This effect is particularly pronounced in non-circular containers which, due to their inherent nature, are more difficult to rotate evenly than rotationally symmetrical containers. However, the method according to the invention eliminates this measurement error because the camera and container remain rotationally invariant relative to each other. Consequently, the method according to the invention is also ideally suited for containers with a non-circular cross-section, such as a rectangular, square, or any other cross-section.

The method according to an example can also be implemented such that the container remains rotationally invariant not only relative to the matrix camera during the capturing of individual captures, but also relative to the system or inspection station as a whole. Specifically, the container can remain stationary during the inspection, i.e., it be moved neither translationally in space nor be rotated. This allows, for example, the detection of small shards inside the container during the inspection which may have been caused by production defects. This was not reliably possible with previous inspection methods, as small shards would adhere to the container's inner walls due to the (sometimes very rapid) rotation of the containers and could then no longer be reliably detected, or they would remain virtually stationary during the rotation due to inertia, while the container's base rotated beneath them. If a shard was located permanently outside the illuminated region, it was never visible in any partial image. In the method according to the invention, however, centrifugal forces that shift shards to the container's inner walls can be prevented. This expands the range of applications of the inspection method.

Preferably, the illumination structure is shifted translationally and/or rotationally relative to the base of the container between two individual captures. Solely translational or solely rotational shifts have the advantage of being relatively easy to implement mechanically. However, a combined translational-rotational shift is also conceivable.

The illumination structure can define, for example, a rectangular, preferably square, or a grid-shaped or strip-shaped illumination region. A rectangular or square illumination region means that a rectangular or square region of the base of the container is illuminated while the remaining region of the container base remains non-illuminated. The advantage of such relatively simple illumination structures is that a readout region of the matrix camera can be particularly well adapted to this shape of illumination structures, even if the illumination structures are shifted and/or rotated relative to the orientation of the matrix camera. In particular, a square illumination region enables particularly short image readout times, i.e., a high capturing speed. A grid-shaped or strip-shaped illumination region, on the other hand, provides the advantage of being able to cover the base of the container with only a very small number of individual captures, possibly with four, three, or in extreme cases even just two individual captures.

A series of individual captures can therefore consist of at least two individual captures, but preferably of at least three, at least four, at least 5, at least 10, or even at least 15, 20, 30, or 50 individual captures.

The angular arrangement of the individual captures relative to one another when compiling the image is preferably carried out as precisely as possible in the same way as the angles of the regions of the base covered by the individual captures are arranged relative to one another.

To exclude any influence from movement of the container during the image capturing, it is advisable to affix the container in its position for the duration of the capturing sequence. A respective fixation device can, for example, clamp the container at the side.

An alternative design for affixing the containers could be a device permanently integrated into the star wheel which not only supports the containers on one side with rollers, but also grasps around them with three or more rollers so that they are rotatable but otherwise firmly anchored in the star wheel. Such a device would be closed after the containers have entered the starwheel and be reopened before they exit the starwheel, while in the starwheel, and especially during the inspection processes, the containers would be affixed and only rotatable.

To avoid an unwanted motion of the container due to the shifting of a support structure defining the illumination structure, it can be useful to divide the image capturing process into several temporally sequential segments. In the first segment, the container reaches the capturing position and is affixed there. In the second segment, the support structure, which previously supported the container base, lowers slightly and is no longer in contact with the now clamped floating container. The motion of the support structure then occurs with the image capturing being synchronized therewith. Finally, the support structure rises again and supports the container again. Ultimately, the fixation device is opened and the container can be moved onward.

It is useful to have software be configured to compile the digital image of the base of the container for identifying special spots in the individual captures and to assemble the images to each other by superimposing the special spots. Such special spots can be, firstly, imperfections, such as the aforementioned defects, cracks, color inclusions, or air inclusions (bubbles). Secondly, special spots can be structures deliberately incorporated into the base of the container, such as text, grooves, or markings. The software can be configured, e.g., by including an image detection module, to detect such special spots and appropriately combine the individual captures such that the best possible match between the special spots arises.

Compiling the digital image of the base of the container can involve a rotation, a linear translation, and/or stretching or compressing one or more individual captures. These measures can be aimed, for example, at creating the best possible superimposition of identified special spots. Artificial intelligence (AI) can be used for compiling the digital image of the base of the container which, by way of suitable self-learning processes, enables optimization of the compilation of the digital image.

It is advantageous to have the digital image of the base of the container be compiled while taking into account the shift or relative rotation between the container and the illumination structure between each two individual captures. The magnitude of this shift or relative rotation between the container and the illumination structure between each two individual captures can be known, be constant, and/or be predetermined by the rotational motion. If the magnitude of the predetermined or performed shift or relative rotation is used as an input variable in the software used to compile the digital image, then this reduces the computing power and time required for compiling the digital image, and the likelihood of incorrect compilation, for example, due to e.g. similar features contained in the image is significantly reduced.

The illumination structure or illumination region is preferably defined by one or more cut-outs in a mask arranged below the base. The mask can be disposed in the support structure or be part of the support structure that is used to support the container during inspection. It would be conceivable for the mask to be exchangeable, for example, to be able to change the shape or dimensions of the illumination region.

The shifting of the illumination structure relative to the base between two individual captures can be caused, for example, in that the mask is moved with a rotational or arcuate motion between two individual captures. The arcuate motion could be performed in such a way that it has a translational projection in plan view. Such an arcuate motion of the mask is particularly suitable in conjunction with a grid-shaped illumination structure.

Preferably, the base of the container rests upon a support structure during the capturing of the individual captures, in particular upon a translucent placement surface, optionally with at least one recess. For example, the light source can be located below the support structure or placement surface while the camera views the base of the container from above. If the base of the container rests upon a support structure, this has the advantage that the base of the container is always disposed in the same plane during the capturing of the series of individual captures. This facilitates focusing the individual captures and thus improves the resolution of the digital image of the base. However, another variant is also conceivable in which an (in particular axially symmetrical) container is mounted in a horizontal orientation during the inspection.

In another variant, the base of the container during the capturing of the individual captures is spaced from a support structure arranged below the base. This variant has the advantage that the support structure, and thus the illumination structure, can be moved relative to the container during the inspection using less force, since there is no friction between the container and the support structure due to the spacing. At the same time, the risk of an unintentional change in position of the container, which could otherwise impair the quality of the images, is reduced.

It has proven to be particularly advantageous to have the individual captures captured by the matrix camera be rectangular in shape, i.e., show a rectangular image. This shape enables particularly high image capturing speeds.

In a second example, the invention relates to a device for creating an image of a translucent or even transparent base of a container, comprising a matrix camera with pixels arranged in a plurality of rows and a plurality of columns, a light source for transilluminating the base of the container, a mask for creating an illumination structure, i.e., structured illumination, and optionally a device for affixing the container. The device comprises a memory for storing a series of individual captures of regions of the base of the container captured by use of the matrix camera. Furthermore, the device comprises an evaluation unit configured to compile a digital image of the base of the container from the series of individual captures. The invention is characterized in that the device is configured to shift the illumination structure relative to the base of the container between two individual captures, and in that the device comprises a holding structure configured to hold the container and the matrix camera in a manner rotationally invariant to one another while the series of individual captures is being captured. This results in the advantages explained above.

It is expedient to have the illumination structure define the region of the base of the container captured in an individual capture. For example, the illumination structure can define a brightly lit and a dark region, and the individual capture captures only the brightly lit region of the illumination structure.

Preferably, the device is configured for translational or rotational shifting of the illumination structure relative to the base of the container between two individual captures. Such shifting of the illumination structure allows for larger parts or even the entire base of the container base to be scanned using relatively simple structural devices.

The device can have a support structure for supporting the container, where the support structure itself comprises or forms a mask. This mask, in turn, can be used to transform large-area illumination into structured illumination, i.e., into an illumination structure.

The illumination structure can define, for example, a rectangular, preferably square, or a grid-shaped or stripe-shaped illumination region. Depending on the intended application and the shape of the containers to be examined, one or the other form of illumination structure can be advantageous.

The holding structure of the device can have a gripper for gripping the container. This gripper can be adjustable between an open and a closed position. The closed position of the gripper allows for the container to be affixed relative to the matrix camera in a rotationally invariant manner; in the open position of the gripper, the container can be picked up in the inspection position or removed from it.

The holding structure can be configured as a clamping device. In this case, the clamping can also be configured on one side and press the container against the opposite star wheel to clamp it.

The features disclosed with regard to the method according to the invention can also be used individually or in combination in the device according to the invention, and vice versa.

### BACKGROUND OF THE INVENTION

The invention shall be further explained hereafter on the basis of embodiments with reference to the figures.

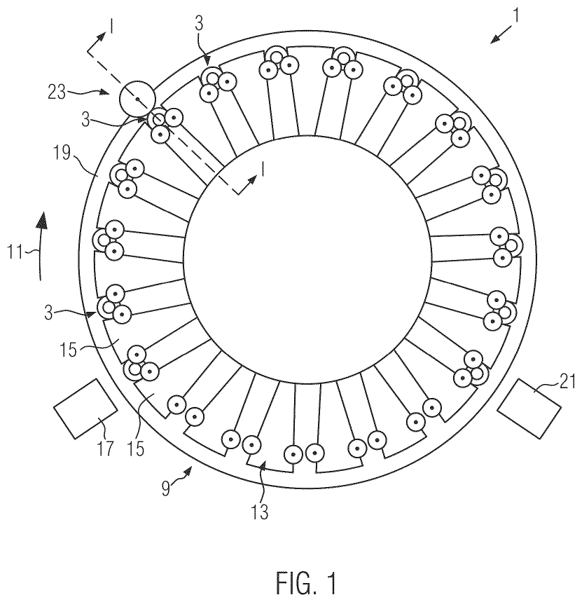

FIG. 1 shows a schematic plan view of a device for inspecting containers.

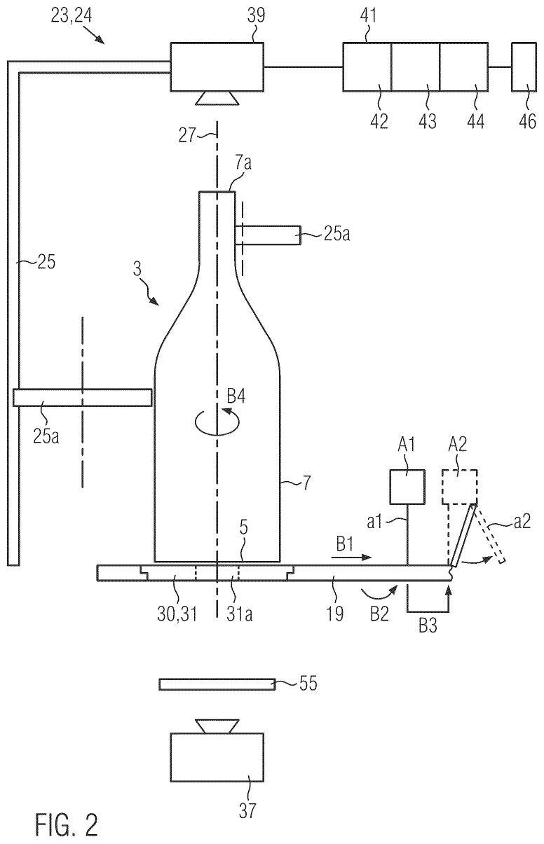

FIG. 2 shows a schematic sectional view of a device for creating an image of the container base according to an embodiment, where the section is indicated by I-I in FIG. 1.

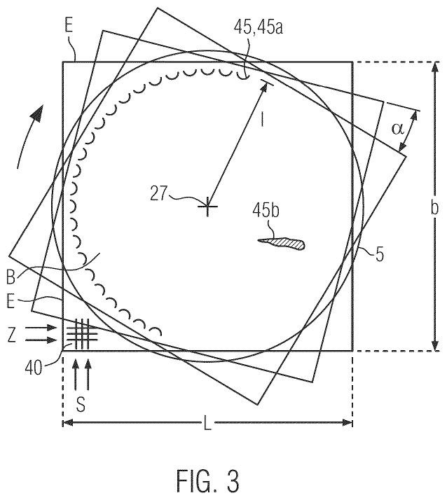

FIG. 3 shows a schematic representation of several individual captures of the base of the container.

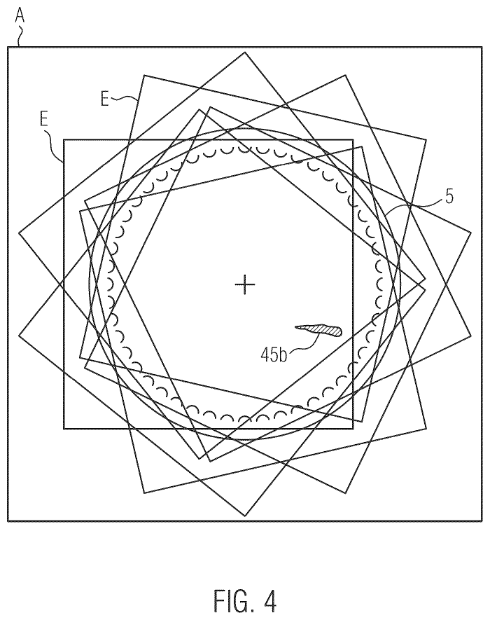

FIG. 4 shows a schematic representation of a compiled image of the base of the container.

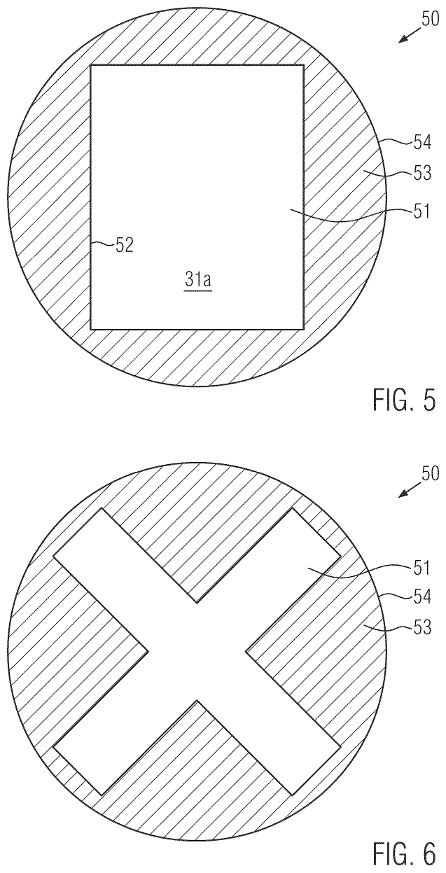

FIG. 5 shows a first embodiment of an illumination structure.

FIG. 6 shows a second embodiment of an illumination structure.

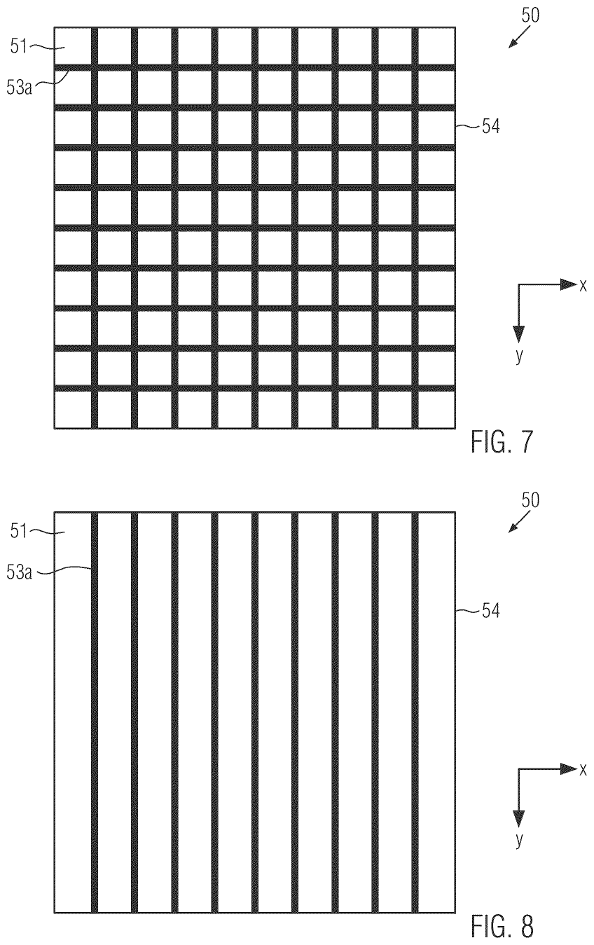

FIG. 7 shows a third embodiment of an illumination structure in plan view.

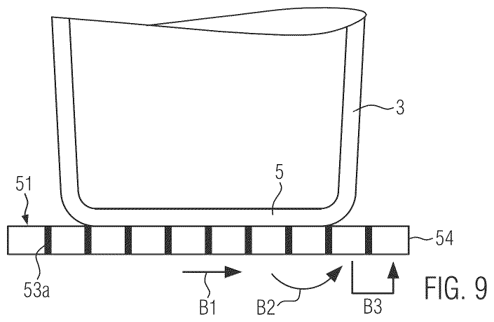

FIG. 8 shows a further embodiment of a grid-shaped or stripe-shaped illumination structure in plan view.

FIG. 9 shows an embodiment of the device with a grid-shaped illumination structure in a vertical sectional view.

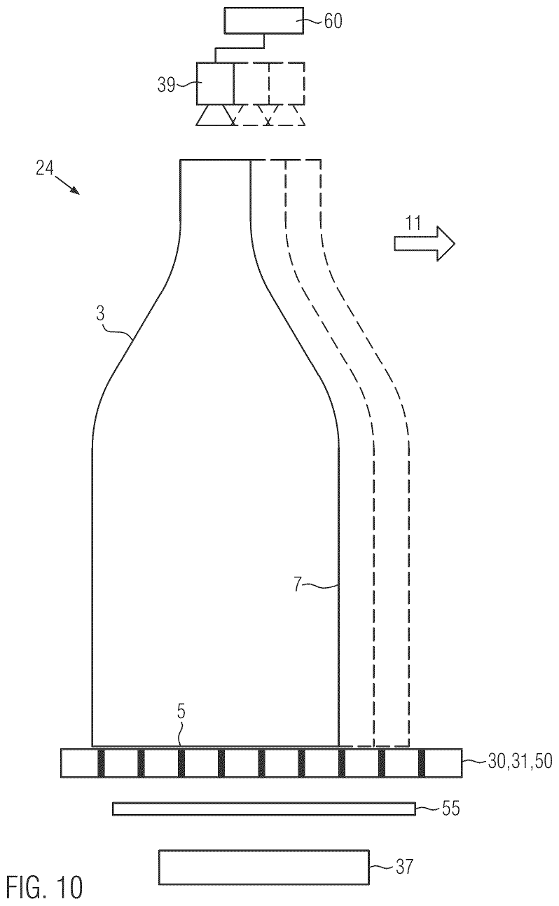

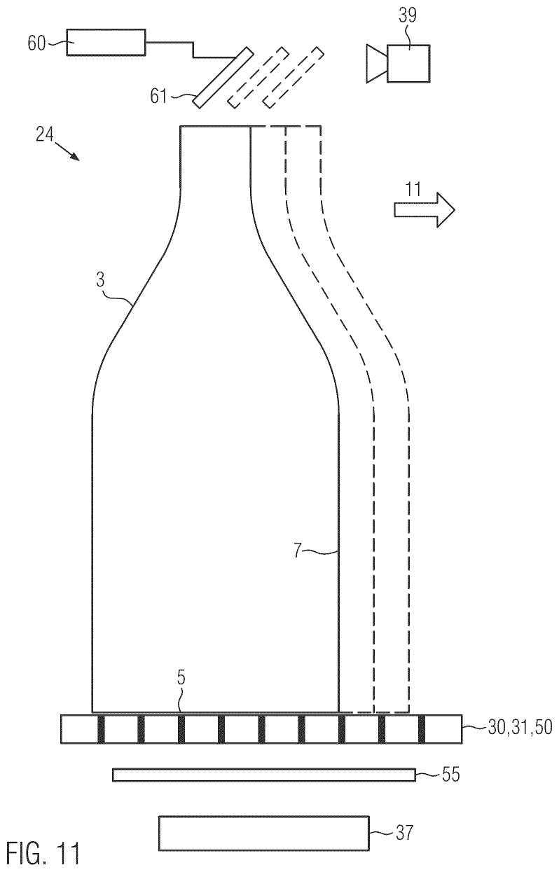

FIG. 10 schematically shows a further embodiment of the device in a side view.

FIG. 11 schematically shows a further embodiment of the device in a side view.

### DETAILED DESCRIPTION

FIG. 1 shows a schematic plan view of a device 1 for inspecting containers 3. As shown in FIG. 2, containers 3 are, for example, plastic or glass bottles with a base 5 and a side wall 7. Alternatively, containers 3 can be other types of jars or bottles, e.g., jam or preserving jars.

As shown in FIG. 1, device 1 comprises a transport device 9 for transporting containers 3 along a direction of transport 11. In the embodiment illustrated, transport device 9 comprises a star wheel 13 which transports containers 3 along a circular path. Star wheel 13 comprises holding elements 15 arranged one behind the other along a circumferential direction of star wheel 13. Containers 3 are transferred from a transfer station 17 to star wheel 13 by being placed between adjacent holding elements 15 of star wheel 13. By rotating star wheel 13, containers 3 are conveyed along direction of transport 11. During conveyance, containers 3 are pushed over a transport surface 19 of transport device 9 by holding elements 15 of star wheel 13. The transportation of containers 3 along direction of transport 11 is carried out in a clocked manner. Once containers 3 have been inspected in device 1, they are removed from transport device 9 by a removal station 21 located with reference to direction of transport 11 downstream of transfer station 17.

An inspection station 23 is provided with reference to direction of transport 11 between transfer station 17 and removal station 21 at which base 5 of container 3 that is respectively present in inspection station 23 is examined for imperfections or defects. During the inspection of a container 3 by inspection station 23, star wheel 13 is preferably at a standstill. During this time, container 3 is therefore preferably not transported along direction of transport 11.

During the inspection of a container 3 in inspection station 23, container 3 is in an inspection position. In the inspection position, container 3 is at rest relative to star wheel 13. If star wheel 13 itself is at a standstill during the inspection, container 3 is at rest overall during the inspection, i.e., also relative to the surroundings of transport device 9, e.g., a factory hall.

FIG. 2 shows a sectional view in the region of inspection station 23 along the section indicated by I-I in FIG. 1. A device 24 according to the invention for creating an image of base 5 of container 3 is arranged at inspection station 23. Device 24 and the most important components of this device, respectively, are shown in FIG. 2.

Container 3 shown in FIG. 2 is in the inspection position. In the inspection position, container 3 stands with its base 5 upon a support structure 30. In the embodiment illustrated, support structure 30 is inserted into a receptacle of transport surface 19. According to embodiments, support structure 30 can be inserted to be exchangeable into transport surface 19. Alternatively, support structure 30 can be formed integrally with transport surface 19. Transport surface 19 and support structure 30 can have upper surfaces that are flush with each other so that bottle 3 can be pushed from transport surface 19 onto support device 30 by star wheel 13.

As shall be explained below, support structure 30 can define an illumination structure 50 in the context of the invention. FIG. 2 shows various options for how support structure 30, and thereby the illumination structure, can be shifted between two individual captures. For example, support structure 30 (optionally together with transport surface 19) can be shifted between two individual captures in a translational motion B1, in an arcuate motion B2, in a substantially U-shaped motion B3 composed of several sections, and/or by a rotatory motion B4 about an axis 27 of container 3. To effect this shifting, various measures are again conceivable. For example, device 24 can comprise a single drive A1 or several drives A1, A2, e.g., servomotors. If multiple drives A1, A2 are present, each can be responsible for its own direction of motion or motion component, resulting overall in, for example, an arcuate or U-shaped shifting B2, B3. For this purpose, each drive A1, A2 is connected to support structure 30 and/or transport surface 19 by way of a suitable operative connection a1, a2. A specific embodiment of such an operative connection a2 can comprise a lever mechanism which is schematically shown in FIG. 2 in two different pivoting positions. The pivoting of such a lever mechanism a2 connected to support structure 30 can cause an arcuate motion b2. If multiple drives A1, A2 are provided, a controller (not shown), e.g., a computer or a microcontroller, can ensure suitable synchronization of the various drives A1, A2.

A matrix camera 39 with a vertically downward viewing direction is arranged above support structure 30. Container 3 is centered with its axis 27 substantially in the viewing direction of matrix camera 39 which is directed from above through an opening 7a of container 7 onto its base 5. Matrix camera 39 is characterized in that its image points (pixels) 40, as shown in FIG. 3, are arranged as a plurality of rows Z and a plurality of columns S, i.e., on an area (instead of just in a single row). Device 24 comprises a fixation device or holding structure 25, respectively, which is configured to hold container 3 and matrix camera 39 in a manner rotationally invariant to one another when the series of individual captures E is captured. Holding structure 25 can comprise a gripper 25a which is configured to grip container 3 and hold it at rest during the inspection. Alternatively, support structure 25 can be configured such that container 3 is clamped between support structure 25 and star wheel 15 in that a clamping element 25a presses laterally against container 3.

A light source 37 is arranged on the side of support structure 30 opposite matrix camera 39, i.e., in the embodiment illustrated, below support structure 30. Light source 37 is used to transilluminate base 5 of the container. For this purpose, support structure 30 can comprise, for example, a translucent placement surface 31 so that the light emitted by light source 37 can pass through base 5 of container 3. One or more recesses 31a through which light can pass can be present in support structure 30 or translucent placement surface 31. Light source 37 can be a pulsed light source, for example, a stroboscopic light source. In this case, the emission of its light pulses can be synchronized with the operation of matrix camera 39, for example by a controller (not shown) of device 24.

On the camera side, an optics system with an integrated beam splitter and two attached cameras 39 can be employed. One of cameras 39 is arranged axially, as shown in FIG. 2, while the other is mounted laterally at a 90° angle to the optic system. Light source 37 is provided with a linear polarizing filter 55 and the camera optic system with a linearly polarizing beam splitter. One camera 39 then sees a bright image, while other camera 39 normally sees nothing because the polarizing filters are arranged in a crossed manner. However, if there is a stress-bearing inclusion (imperfection) in bottle base 5, then the polarization plane is rotated and second camera 39 sees the stress source as a bright spot. Two cameras 39 are therefore used for normal base examination and stress examination. The use of a station 23 with only one camera without polarization evaluation is alternatively also conceivable. The use of image sensors with an upstream polarizing filter is also possible.

FIG. 3 shows a schematic representation of several individual captures E being captured by matrix camera 39. Due to the orientation of matrix camera 39 and the arrangement of its pixels 40 in several rows Z and columns S, each individual capture E consists of a stripe-shaped region B of base 5 of container 3—preferably a square region B. In FIG. 3, captured region B of base 5 is the intersection between circular base 5 of container 3 and the total area of individual capture E. As mentioned at the outset, base 5 or the cross-section of container 3 do not have to be circular, but can have any shape, e.g., rectangular, square (in general: polygonal). Each individual capture E covers a specific length L and a specific width b. In one variant, length L and width b are equal in size (or approximately equal in size) and each is approximately 5 to 10% smaller than the diameter (2×1) of container 3.

While a series of individual captures E of base 5 of a container 3 is created, a shift of the illumination structure relative to base 5 of the container occurs between different individual captures E, e.g., a shift and/or a relative rotation. The relative rotation between two individual captures E can occur by an angle α of, for example, 10 to 15°, preferably by an angle of 2° to 12°.

Device 24 comprises an evaluation unit 41 which can be integrated into matrix camera 39 or connected to matrix camera 39. Evaluation unit 41 comprises a memory 42 for storing a series of individual captures E as well as a computer 43 on which a computer program product 44 is installed. Evaluation unit 41, or specifically computer program product 44 installed therein, is configured to compile a digital image of base 5 from a series of individual captures E of a base 5 of container 3. FIG. 3 indicates in what manner this can be done:

There is a plurality of special spots 45 in base 5 of container 3. Special spots 45 can be indentations 45a selectively introduced into base 5, e.g., circumferential indentations 45a, or an undesired imperfection 45b, e.g., a bubble or a crack. An image recognition module of computer program product 44 is configured to recognize such special spots 45 in individual captures E. Evaluation unit 41 is then configured to manipulate individual captures E in such a way that an optimal superimposition of special spots 45 in respective individual captures E is obtained. The manipulation can comprise a rotation of respective individual captures E (e.g., but not necessarily, about axis 27 of container 3), a translation of individual captures E in their longitudinal and/or transverse direction and/or stretching or compressing respective individual captures E.

When all individual captures E of a series have been processed by evaluation unit 41, it has created a digital image A of base 5 of container 3, as shown in FIG. 4. Digital image A is compiled from respective individual captures E, where individual captures E are arranged at an angle relative to one another. As a result, this does not produce an “unwinding” of base 5 with corresponding distortions, but rather a distortion-free image of base 5 of container 3.

To facilitate the evaluation and compilation of image A, evaluation unit 41 can take into account angle α (see FIG. 3) as an input variable, by which the illumination structure is shifted, e.g., rotated, relative to container 3 between two individual captures E. This input variable makes it easier for evaluation unit 41 to compile digital image A, as the probability of the need to shift, move, or rotate individual captures E is reduced.

If device 1, inspection station 23, or device 24 has a display 46 (see FIG. 2), then digital image A can be displayed there. Alternatively, digital image A can be evaluated mechanically. If imperfections 45b are detected, respective container 3 can be discharged manually or in an automated manner.

FIG. 5 schematically shows a plan view of an illumination structure 50. In this comparatively simple embodiment, illumination structure 50 comprises a central bright illumination region 51 (i.e., a region of high light intensity) having a rectangular contour 52. Bright region 51 is surrounded by an annular dark region 53, i.e., a region of low light intensity. Illumination structure 50 can be created in that a mask 54 (e.g., one that can be inserted into or integrated into support structure 19) with a central recess 31a is provided. Central recess 31a defines illumination region 51, i.e., bright region 51 of illumination structure 50. Recess 31a can be free (i.e., formed as a hole) or formed by a transparent or translucent material, e.g., sapphire glass. The shifting of illumination structure 50 relative to base 5 of container 3 can be achieved in that mask 54 is shifted. The size of recess 31a can be selected such that it is smaller than a dimension of container 3 so that container 3 can stand on mask 54 during the capturing of individual captures E.

The use of a mask 54 has the advantage that the use of a large-region or even full-region light source 37 is enabled, as well as the optional use of a polarizing filter 55 between light source 37 and container 3 (see FIG. 2), and that neither light source 37 nor (if present) polarizing filter 55 need to be shifted relative to container 3 for shifting illumination structure 50 during inspection.

FIG. 6 shows a second embodiment of an illumination structure 50. It differs from the embodiment shown in FIG. 5 only in that illumination region 51, i.e., the bright region of illumination structure 50, is not shaped to be square, but cross-shaped. Various other shapes of illumination region 51 are conceivable, for example, a rectangular shape.

FIG. 7 shows a further embodiment of an illumination structure 50. This illumination structure 50 is grid-shaped, i.e., it comprises a regular two-dimensional arrangement of bright fields 51 between which dark regions or webs 53a are located. In the present embodiment, grid-shaped illumination structure 50 has a number of 10×10 bright fields 51.

While FIG. 7 shows an illumination structure 50 in the shape of a two-dimensional grid, FIG. 8 shows an embodiment of an illumination structure 50 in a stripe-shaped or one-dimensional grid shape. In this embodiment, webs 53a are provided only in the y-direction. Stripe-shaped bright (i.e., illuminated) fields or stripes 51, respectively, extend between webs 53a. Embodiments of such a stripe-shaped illumination structure 50 are conceivable and advantageous in which the width of webs 53a in the x-direction is approximately 40 to 60 percent of the width of a bright region (stripe) 51 in the x-direction. In other words, in such an embodiment, each web 53a has approximately half the width of a bright region or stripe 51, respectively. Specifically, for example, each web 53a could have a width of 5 to 10 millimeters, while each bright region, slit, or stripe 51 could have an extension of 10 to 20 millimeters in the x direction. Variations of these proportions are, of course, conceivable.

An advantage of a grid-shaped illumination structure 50 like in FIG. 8 or 9 is that webs 53a can ensure increased strength and therefore improved bearing strength of mask 54 for container 3. A further advantage becomes clear in the vertical sectional view shown in FIG. 9. The lower part of container 3 is indicated there which stands with its base 5 on mask 54 as part of support structure 19 during the inspection. The grid-shaped illumination structure 50 enables the compilation of a (digital) image A of any point on the container base 50 using a minimal number of just two individual captures E. For this purpose, only illumination structure 50 needs to be offset between two individual captures E in both the x-direction and the y-direction (see the coordinate system in FIG. 7) by a distance that does not correspond to an integer grid spacing. For example, shifting in the x-direction and in the y-direction can be achieved by, for example, 0.4 to 0.6 times the grid spacing, for example, 0.5 times the grid spacing. The shifting of illumination structure 50 can be achieved by moving mask 54. Various options are available for this. For example, mask 54 could be shifted in its plane by a solely translational motion B1. Alternatively, mask 54 could be shifted between two individual captures by an arcuate motion B2. Arcuate motion B2 has the advantage that, during the shifting of illumination structure 50, less or even no frictional forces act upon base 5 of container 3, which further increases the positional stability of container 3. This could be further improved by a U-shaped motion B3, in which the structure or mask 54, respectively, is first moved axially downwardly until there is no longer any contact with container 3, and only then is it moved translationally.

Depending on the technical configuration of the overall system and, above all, the number of images to be captured per container and the number of containers per unit of time, a fast to very fast camera can be used as matrix camera 39. For example, cameras with an interface of 1, 5, 10, or more gigabits per second are conceivable. The image region of camera 39 is preferably selected to be large enough to always capture the entire illumination region 51—regardless of its orientation relative to the image. Synchronization between the captured image and the respective orientation of illumination structure 50 can be achieved either solely through image processing, for example, in that image recognition software independently searches for illuminated region 51 in respective individual capture E. Alternatively, to improve process stabilization, the selectively performed shifting of illumination structure 50 between individual captures E can be taken into account, for example, the size of the selectively performed shifting and/or rotation of the illumination structure.

It is conceivable that the total duration of capturing a series S of individual captures is completed in less than 100 milliseconds, preferably even within 75 milliseconds or less. This enables a very high throughput of the inspection device, i.e., a high number of containers inspected per unit of time.

FIG. 10 schematically shows a side view of a further embodiment of a device 24 according to the invention for creating an image A of base 5 of a container 3. In this embodiment, containers 3 are transported while their base 5 rests upon a support structure 30, for example, a translucent placement surface 31. Placement surface 31 is configured to define, for example, a stripe-shaped illumination structure 50 with alternating light and dark stripes. Placement surface 31 is illuminated from below by a light source 37.

The drinking containers 3 are transported in a direction of transport 11, for example, on a star wheel 13 (see FIG. 1). FIG. 10 schematically shows three different states: namely an initial state (with solid lines of the container), and the positions of container 3 at two later points in time with dashed lines. It would be conceivable for container 3 to be at a standstill in the middle one of the three positions (which enables particularly precise capturing), and for the other two positions to be shortly before and shortly after the standstill, for example, at distances of approximately 7 to 14 mm from the standstill position.

In this exemplary embodiment, matrix camera 39 is temporarily moved synchronously with the motion of container 3. This is ensured by an actuator 60, which temporarily couples the motion of matrix camera 39, for example, with the transport speed of container 3 on star wheel 13. In this exemplary embodiment, the series captured by matrix camera 39 could consist of, for example, three individual captures E. However, any other (in particular higher) number of individual captures E would also be conceivable.

FIG. 11 shows a modification of the embodiment from FIG. 10. In contrast to FIG. 10, actuator 60 there does not move matrix camera 39 with the container; instead, actuator 60 temporarily moves a camera optic system 61 synchronously with the motion of container 3 along direction of transport 11. Camera optic system 61 can be, for example, a mirror or mirror optic system.

Based on the embodiments illustrated and the appended claims, the invention can be modified in various ways. One possibility, for example, is to capture and inspect individual images E (visually or mechanically) before or even without a digital image A of base 5 of container 3 being compiled from several images.

What is claimed is:

1. Method for creating an image of a translucent or transparent base of a container,
wherein a matrix camera with pixels arranged in a plurality of rows and a plurality of columns is provided,
wherein a series of individual captures of regions of said base of said container is captured using said matrix camera, wherein adjacent individual captures overlap in sections,
wherein during an individual capture, said base of said container is transilluminated by a light source located on the side of said base of said container opposite said matrix camera,
and wherein a digital image of said base of said container is compiled from the series of individual captures,
wherein said region of said base of said container captured in an individual capture is defined by an illumination structure,
that said illumination structure is shifted relative to said base of said container between two individual captures,
and that said container and said matrix camera remain rotationally invariant to one another during the capturing of the series of individual captures.

2. Method according to claim 1, wherein said illumination structure is shifted translationally and/or rotationally relative to said base of said container between two individual captures.

3. Method according to claim 1, wherein said illumination structure defines a rectangular, preferably square, or grid-shaped or stripe-shaped illumination region.

4. Method according to claim 3, wherein said illumination region is defined by one or more cut-outs in a mask arranged below said base.

5. Method according to claim 4, wherein said mask is shifted between two individual captures in a rotational, translational, arcuate, or combined motion.

6. Method according to claim 1, wherein said base of said container during the capturing of said individual captures is spaced from a support structure arranged below said base.

7. Method according to claim 1, wherein said individual captures captured by said matrix camera have a rectangular or square shape.

8. Method according to claim 1, wherein the series of individual captures is created while said container is being transported in a direction of transport relative to said illumination structure.

9. Device for creating an image of a translucent or transparent base of a container, comprising a matrix camera with pixels arranged in a plurality of rows and a plurality of columns, a light source for transilluminating said base of said container, and a mask for creating an illumination structure,
wherein a memory is provided for storing a series of individual captures of regions of said base of said container captured by said matrix camera,
and wherein said device comprises an evaluation unit configured to compile a digital image of said base of said container from the series of individual captures,
wherein said device is configured to shift said illumination structure relative to said base of said container between two individual captures,
and that said device comprises a holding structure configured to hold said container and said matrix camera in a manner rotationally invariant to one another when the series of individual captures is captured.

10. Device according to claim 9, wherein said illumination structure defines said region of said base of said container captured in an individual capture.

11. Device according to claim 9, wherein said device is configured for translational and/or rotational shifting of said illumination structure relative to said base of said container between two individual captures.

12. Device according to claim 9, wherein a support structure for supporting said container, wherein said support structure comprises or forms a mask.

13. Device according to claim 9, wherein said illumination structure defines a rectangular, preferably square, or grid-shaped illumination region.

14. Device according to claim 9, wherein said holding structure comprises a gripper for gripping or clamping said container.

15. Device according to claim 9, wherein it comprises an actuator configured to temporarily move said matrix camera or a camera optic system of said matrix camera synchronously with a motion of said container.
